(19) United States
(12) Patent Application Publication
(10) Pub. No.: US 2013/0342713 A1
(43) Pub. Date: Dec. 26, 2013

(54) CLOUD SERVICE BASED INTELLIGENT PHOTOGRAPHIC METHOD, DEVICE AND MOBILE TERMINAL

(71) Applicant: XI'AN LIANKE INFORMATION TECHNOLOGY CO., LTD., XI'AN CITY (CN)

(72) Inventor: GANG CUI, XI'AN CITY (CN)

(73) Assignee: XI'AN LIANKE INFORMATION TECHNOLOGY CO., LTD., XI'AN CITY (CN)

(21) Appl. No.: 13/975,263

(22) Filed: Aug. 23, 2013

Related U.S. Application Data
(63) Continuation of application No. PCT/CN2012/078430, filed on Jul. 10, 2012.

(30) Foreign Application Priority Data
Mar. 20, 2012 (CN) 201210074343.3

(51) Int. Cl. H04N 5/232

(52) U.S. Cl. CPC H04N 5/23222
USPC 348/207.11

(57) ABSTRACT

Provided in the present invention is a cloud service based intelligent photographic method, device and mobile terminal. The cloud service based intelligent photographic method includes: acquiring current environment information and device information of a mobile terminal, transmitting the environment information and device information to a cloud service device, so that the cloud service device generates photographic parameters corresponding to the environment information and device information; and receiving the photographic parameters transmitted by the cloud service device, and setting a photographic module of the mobile terminal according to the photographic parameters. Since the photographic parameters generated according to current environment information and device information can be received from the cloud service device, the photographic parameters can be aimed at the current environment features and adapted to hardware setting of the mobile terminal, thus intelligent setting of the photographic parameters can be achieved and photographing effect can be greatly enhanced.

### CROSS REFERENCE TO RELATED APPLICATIONS

This application is a continuation application of International Application No. PCT/CN2012/078430, filed on Jul. 10, 2012 which claims priority benefit of Chinese Patent Application No. 201210074343.3, filed on Mar. 20, 2012, and entitled “Cloud Service Based Intelligent Photographic Method, Device and Mobile Terminal”. The contents of the above identified applications are incorporated by reference in their entireties.

### FIELD OF THE TECHNOLOGY

The present invention relates to the field of mobile terminals, and more particularly to a cloud service based intelligent photographic method, device, and mobile terminal.

### BACKGROUND

With the development of the mobile terminal technology, mobile terminals, such as smart phones, tablet computers can realize more and more abundant functions. Generally, the mobile terminal is integrated with a camera, which can realize functions to take pictures and videos, and thus can greatly enrich people's life.

In order to take pictures or videos with a higher quality or a particular style, a user generally needs to set photographic parameters of the mobile terminal in the process of taking pictures or videos. However, the photographic parameters are rather complicated, and settings of the photographic parameters in different circumstances are different, it is difficult for an ordinary user to master and shoot satisfactory works.

### SUMMARY

The present invention provides a cloud service based intelligent photographic method, device, and mobile terminal, to realize intelligent setting of the photographic parameters and to enhance photographing effect of a mobile terminal.

One aspect of the present invention provides a cloud service based intelligent photographic method, comprising:
acquiring current environment information and device information of a mobile terminal, transmitting the environment information and the device information to a cloud service device, so that the cloud service device generates photographic parameters corresponding to the environment information and the device information; and
receiving the photographic parameters transmitted by the cloud service device, and setting a photographic module of the mobile terminal according to the photographic parameters.

Another aspect of the present invention provides a cloud service based intelligent photographic device, comprising:
an information acquisition module, configured to acquire current environment information and device information of a mobile terminal, transmit the environment information and device information to a cloud service device, so that the cloud service device generates photographic parameters corresponding to the environment information and the device information; and
a parameter setting module, configured to receive the photographic parameters transmitted by the cloud service device, and set a photographic module of the mobile terminal according to the photographic parameters.

Still another aspect of the present invention provides a mobile terminal comprising a photographic module, further comprising:
the cloud service based intelligent photographic device provided in the present invention.

Seen from the above technical solutions, in the cloud service based intelligent photographic method provided in one aspect of the present invention, the intelligent photographic device acquires current environment information and device information of a mobile terminal, transmits the environment information and the device information to a cloud service device, so that the cloud service device generates photographic parameters corresponding to the environment information and the device information, and receives the photographic parameters transmitted by the cloud service device, and sets a photographic module of the mobile terminal according to the photographic parameters. Since the intelligent photographic device can receive photographic parameters generated according to current environment information and device information from the cloud service device, the photographic parameters can be aimed at the current environment features and adapted to hardware setting of the mobile terminal, a user can shoot high-quality photographic works even without any photographic experience, thus intelligent setting of the photographic parameters can be achieved and photographing effect of the mobile terminal can be greatly enhanced.

In the cloud service based intelligent photographic device provided in another aspect of the present invention, an information acquisition module acquires current environment information and device information of a mobile terminal, and transmits the environment information and the device information to a cloud service device, so that the cloud service device generates photographic parameters corresponding to the environment information and the device information. A parameter setting module receives the photographic parameters transmitted by the cloud service device, and sets a photographic module of the mobile terminal according to the photographic parameters. Since the intelligent photographic device can receive photographic parameters generated according to current environment information and device information from the cloud service device, the photographic parameters can be aimed at the current environment features and adapted to hardware setting of the mobile terminal, a user can shoot high-quality photographic works even without any photographic experience, thus intelligent setting of the photographic parameters can be achieved and photographing effect of the mobile terminal can be greatly enhanced.

In the mobile terminal provided in still another aspect of the present invention, the mobile terminal is provided with a cloud service based intelligent photographic device, the cloud service based intelligent photographic device acquires current environment information and device information of the mobile terminal, transmits the environment information and the device information to a cloud service device, so that the cloud service device generates photographic parameters corresponding to the environment information and the device information, and receives the photographic parameters transmitted by the cloud service device, and sets a photographic module of the mobile terminal according to the photographic parameters. Since the intelligent photographic device can receive photographic parameters generated according to current environment information and device information from the cloud service device, the photographic parameters can be aimed at the current environment features and adapted to hardware setting of the mobile terminal, a user can shoot high-quality photographic works even without any photographic experience, thus intelligent setting of the photographic parameters can be achieved and photographing effect of the mobile terminal can be greatly enhanced.

### BRIEF DESCRIPTION OF THE DRAWINGS

FIG. 1 is a flow chart of a cloud service based intelligent photographic method provided in Embodiment 1 of the present invention;

FIG. 2 is a structural schematic diagram of a cloud service based intelligent photographic device provided in Embodiment 3 of the present invention;

FIG. 3 is a structural schematic diagram of a cloud service based intelligent photographic device provided in Embodiment 4 of the present invention;

FIG. 4 is a structural schematic diagram of a mobile terminal provided in Embodiment 5 of the present invention; and

FIG. 5 is a structural schematic diagram of a mobile terminal provided in Embodiment 6 of the present invention.

### DETAILED DESCRIPTION

### Embodiment 1

FIG. 1 is a flow chart of a cloud service based intelligent photographic method provided in Embodiment 1 of the present invention. As shown in FIG. 1, the cloud service based intelligent photographic method provided in this embodiment can particularly be applied in the process of acquiring photographic parameters when photographing with a mobile terminal, and can be achieved by an intelligent photographic device, which can be integrated in the mobile terminal or be set separately, and can be realized in a manner of software and/or hardware. The mobile terminal particularly can be a mobile device with photographing function, such as a cell phone, a tablet computer, a digital camera or a wearable terminal.

The cloud service based intelligent photographic method provided in this embodiment includes:

Step 10, acquiring current environment information and device information of a mobile terminal, transmitting the environment information and the device information to a cloud service device, so that the cloud service device generates photographic parameters corresponding to the environment information and the device information;

Particularly, the current environment information is to indicate the photographing environment and a specific scene to be photographed, in order to take pictures or videos with high quality, an experienced user usually needs to set the photographic parameters of a photographic module of the mobile terminal according to the current environment, that is, the current environment information is instructive for the photographing. For example, the environment information includes position information of a mobile terminal, orientation information of a user, time information, environmental noise information, light information and subject information to be photographed. The device information particularly can be model of a mobile terminal, lens model and etc. Different mobile terminals have different hardware configurations, and thus parameter setting ranges of the mobile terminal may also be different.

The cloud service device particularly is a device with complex information analysis function, which can analyze the received environment information and device information to generate photographic parameters corresponding to the environment information and the device information. The cloud service device also can be provided with an expert database, which stores a large number of photographic parameters adaptive to different environments and mobile terminal devices, then one or more sets of photographic parameters matched with the received environment information and the received device information can be acquired by querying the expert database according to the environment information and the device information.

The user can pre-register on the cloud service device, and the cloud service device can make statistics on the photographing preferences of the user. The user can upload the photographic parameters set in each photographing to the cloud service device, the cloud service device stores the user's history information to make statistics on the preferences of the user, further selects or modifies the photographic parameters according to the preferences of the user, or sorts the multiple sets of the photographic parameters according to the preferences of the user, and sent the photographic parameters according to the order. The cloud service device also can make statistics on a large number of photographic parameters uploaded by users, and update the photographic parameters of the higher-quality photographic works to the expert database. The cloud service device also can update the expert database according to the recommended parameters of different mobile terminal manufacturers.

Step 20, receiving the photographic parameters transmitted by the cloud service device, and setting a photographic module of the mobile terminal according to the photographic parameters.

Particularly, the intelligent photographic device can receive multiple sets of photographic parameters sent by the cloud service device, and the user can select one set on his or her own demands to set the photographic module, and also can use the received photographic parameter as reference, and make proper adjustment on the received photographic parameters.

The photographic parameters can include a hardware regulating parameter and a software processing parameter. The hardware regulating parameter can include a focal distance parameter, an aperture parameter, a shutter parameter, an exposure compensation parameter, and a photosensibility parameter, and etc. The intelligent photographic device can correspondingly set the hardware of the photographic module according to the hardware regulating parameter. The software processing parameter can include a nonlinear processing parameter, a color temperature processing parameter, a brightness processing parameter, a contrast processing parameter, a saturation processing parameter, a hue processing parameter, an exposure processing parameter, and etc. The intelligent photographic device can transmit the software processing parameter to the photographic module, so that the photographic module can correspondingly process the video stream acquired in real time according to the software processing parameter.

Thus, the user can perform a photographing operation via the set mobile terminal. The user also can set the photographing mode of the mobile terminal to an automatic mode, once the user triggers the photographing operation, the intelligent photographic device can complete the above processes of acquiring information, transmitting information, receiving photographic parameters, setting photographic module and storing images, thus a user can shoot high-quality photographic works even without any photographic experience.

In the cloud service based intelligent photographic method provided in this embodiment, the intelligent photographic device acquires current environment information and device information of a mobile terminal, transmits the environment information and the device information to a cloud service device, so that the cloud service device generates photographic parameters corresponding to the environment information and device information, and receives the photographic parameters transmitted by the cloud service device, and sets a photographic module of the mobile terminal according to the photographic parameters. Since the intelligent photographic device can receive photographic parameters generated according to current environment information and device information from the cloud service device, the photographic parameters can be aimed at the current environment features and adapted to hardware setting of the mobile terminal, a user can shoot high-quality photographic works even without any photographic experience, thus intelligent setting of the photographic parameters can be achieved and photographing effect of the mobile terminal can be greatly enhanced.

### Embodiment 2

The cloud service based intelligent photographic method provided in this embodiment is based on the embodiment in FIG. 1, and the acquiring current environment information in Step 10, particularly includes the following steps:
acquiring the current position information from a positioning module of the mobile terminal, acquiring current orientation information from a direction detection module of the mobile terminal, acquiring current time information from a time module of the mobile terminal, and forming the environment information based on the position information, the orientation information and the time information.

Particularly, the mobile terminal is generally integrated with a positioning module, a direction detection module and a time module in advance, and the above functional modules can be used to automatically acquire the environment information. The positioning module particularly can be a base station Cell ID (Cell Identification) positioning module, which acquires the geographical location of the base station according to the cell number of the base station in which the mobile terminal is situated, and estimates the position information of the mobile terminal according to the geographical location of the base station. The positioning module also can be a base station triangulation positioning module, which obtains times of arrival (Time of Arrival, TOA) of downlink pilot signals from different base stations by measuring the downlink pilot signals from different base stations, and calculates the position of the mobile terminal by using a trigonometry formula estimation method according to the measurement result in combination with coordinates of the base station. The positioning module also can be a global positioning system (Global Positioning System, GPS) module, which utilizes a global positioning system, and takes a momentary position of a high-speed satellite as a given initial data and adopts a space resection method to determine position information of a mobile terminal. The position information particularly can be longitude and latitude information. The direction detection module can sense the directionality of the mobile terminal. The direction detection module can be provided with an electronic compass and a three-axis gyroscope, so as to assist in achieving acquisition and determination of accurate orientation information of the mobile terminal The time module can provide a system time of the mobile terminal, that is, the current time.

The above information is transmitted to the cloud service device as the environment information, and the cloud service device can acquire weather information according to the position information and time information, the weather information can be acquired from a specialized weather information server which can be integrated in the cloud service device. The cloud service device can judge and learn information such as, the current weather condition, mist penetration, visibility and ambient light according to the weather information, and can judge whether the user is currently facing the light or against the light according to the orientation information, the cloud service device makes comprehensive analysis on the environmental situation in which the user is located and can generate desirable photographic parameters adaptive to the current environment. When the mobile terminal has a weather information acquisition function, the mobile terminal also can directly transmit the above information to the weather server, receive the weather information returned by the weather server according to the above information, and transmit the weather information as the environment information to the cloud service device.

The above environment information also can be information manually input by a user, for example, the user can input his or her own position information, the orientation information and the current time information, and the position information can be acquired by various manners, which is not limited to this embodiment.

Further, in this embodiment, before the forming the environment information based on the position information, the orientation information and the time information in the above step, the method can particularly include following steps:
acquiring environmental noise information from a sound acquisition module of the mobile terminal, acquiring a frame of image of a video stream acquired by the photographic module in real time as an image to be photographed, and generating subject information to be photographed according to the image to be photographed;
correspondingly, the forming the environment information based on the position information, the orientation information and the time information, includes:
forming the environment information based on the position information, the orientation information, the time information, the environmental noise information and the subject information to be photographed.

Particularly, the mobile terminal also can be integrated with a sound acquisition module, when the mobile terminal is a cell phone or a tablet computer, the sound acquisition module can be a microphone module. The sound acquisition module can be used to acquire environmental noise information. Taking the environmental noise information as the environment information, the cloud service device can judge the specific position of the user more accurately according to the difference in environmental noise information, such as the specific position in the building, indoor or outdoor, so as to modify the photographic parameters with respect to different positions.

The subject information to be photographed is an indication information which can be used to indicate the current object to be photographed is a person, or a text of a scene, or a scene, and the subject information to be photographed can be determined by face recognition technique or text recognition technique, if a face is recognized in the image, the object currently photographed is a person, if a text is recognized in the image, the object currently photographed is a text, and if both a face and a text are not recognized in the image, the object currently photographed is a scene. The subject information to be photographed also can be an indication information which can be used to indicate that the object currently photographed is a graphical logo on an article or an outline of an article, graphics and image recognition technique can be adopted to recognize the graphical logo on the article, or, to extract the outline of the article. The subject information to be photographed also can be directly a frame of image of a video stream acquired by the photographic module, i.e. the image to be photographed. The photographic parameters for photographing a person and a scene are different, and the cloud service device can further modify the photographic parameters according to the subject information to be photographed. By taking the environmental noise information and the subject information to be photographed as the environment information, the cloud service device can make more comprehensive analysis on the environmental situation in which the user is located, so that the photographic parameters can be more targeted.

Further, in this embodiment, before the forming the environment information based on the position information, the orientation information and the time information in the above step, particularly includes the following steps:
acquiring light information from a light acquisition module of the mobile terminal;
correspondingly, the forming the environment information based on the position information, the orientation information and the time information form particularly includes:
forming the environment information based on the position information, the orientation information, the time information, and the light information.

Particularly, the mobile terminal also can be integrated with a light acquisition module, the light acquisition module can acquire the light value, i.e., the light information, around the mobile terminal, and transmit the light information as the environment information to the cloud service device, which can further modify the specific environment in which the user is located according to the light information, for example, the user is currently located outdoor under shelter, the cloud service device only can determine the user's position according to the position information, the orientation information and the time information, but fail to judge whether the user is in the scorching sun or under shelter. The ambient lights in the scorching sun or under shelter are different, the mobile terminal can further modify the photographic parameters recommended to the user according to the light information, and the photographic parameters can be more reasonable.

In practical application, the environment information also can include position information, orientation information, time information, light information, environmental noise information, and subject information to be photographed, the corresponding information can be acquired based on the settings of the functional modules of the mobile terminal and is not limited to this embodiment.

In this embodiment, the Step 20, the receiving the photographic parameters transmitted by the cloud service device, and setting a photographic module of the mobile terminal according to the photographic parameters, particularly includes the following steps:

Step 201, receiving multiple sets of the photographic parameters transmitted by the cloud service device, and displaying the multiple sets of photographic parameters via a display module of the mobile terminal;

Step 202, according to received parameter selection information input by a user, determining the photographic parameters corresponding to the parameter selection information, and setting the photographic module according to the photographic parameters corresponding to the parameter selection information.

Particularly, the user can set the photographing mode to a manual mode, then the cloud server device can send multiple sets of photographic parameters to the intelligent photographic device, and the intelligent photographic device can display the multiple sets of photographic parameters to the user via the display module of the mobile terminal. The multiple sets of the photographic parameters can be displayed in sequence, according to the preferences of the user, and be selected on user's own demand.

The parameter selection information is the indication information input by the user for indicating to select a certain set of or some photographic parameters. When the display module of the mobile terminal adopts a touch screen, the user can select by touch, and the intelligent photographic device sets the photographic module according to the photographic parameters selected by the user. After the setting, the user can preview in real time the effect of the image to be photographed after the photographic parameters are set via the display module, if the current effect is satisfied, then manually trigger the photographing operation, so as to obtain higher-quality photographic works.

The intelligent photographic device also can locally store the multiple sets of photographic parameters transmitted by the cloud service device, and return to the photographic parameter selection mode to select other photographic parameters, when the user is not satisfied with the image effect.

In this embodiment, after setting the photographic module of the mobile terminal according to the photographic parameters in Step 20, the method particularly includes the following steps:

Controlling the photographic module to perform a photographing operation.

The user also can set the photographing to an automatic mode, then, after setting the photographic module, the intelligent photographic device can automatically control the photographic module to perform photographing operation. In the automatic mode, the cloud service device can send a set or multiple sets of photographic parameters to the intelligent photographic device, and the intelligent photographic device can set the photographic module by selecting the photographic parameters ranked first.

In this embodiment, the photographic parameters include at least one of the following: a nonlinear processing parameter, a color temperature processing parameter, a brightness processing parameter, a contrast processing parameter, a saturation processing parameter, a hue processing parameter, an exposure processing parameter, a focal distance parameter, an aperture parameter, a shutter parameter, an exposure compensation parameter, and a photosensibility parameter.

In practical application, multiple users may be photographing at the same time and in the same environment, such as the same scenic spot or the site of a certain concert, then the cloud service device can determine at least two mobile terminals with consistent environment information and the device information, and establish photographic parameter sharing between the at least two mobile terminals, that is, the user can receive via the mobile terminal the photographic parameters shared by other users and transmitted by the cloud service device. Not only the photographic parameter sharing can improve interactivity between users, but also the user can share photographic experience and learn from each other in this manner, so that user with no photographic experience can directly share photographic parameters from the experienced user and finish good photographic works.

The user also can upload the photographed picture or video to the cloud service device via the mobile terminal, the cloud service device can determine at least two mobile terminals with consistent environment information and the device information, establish picture or video sharing between the at least two mobile terminals, that is, the user can receive the picture or video shared by other users and transmitted by the cloud service device via the mobile terminal. The cloud service device also can provide the user with point of interest (Point of Interest, POI) information according to user's environment information, and transmit the POI information to the mobile terminal in a manner of a map, or other picture or text, so as to present to the user, and the POI information can remind the user of the branch road condition and detailed information of the surrounding buildings, so that the information volume of the user can be improved and user's travel can be facilitated.

### Embodiment 3

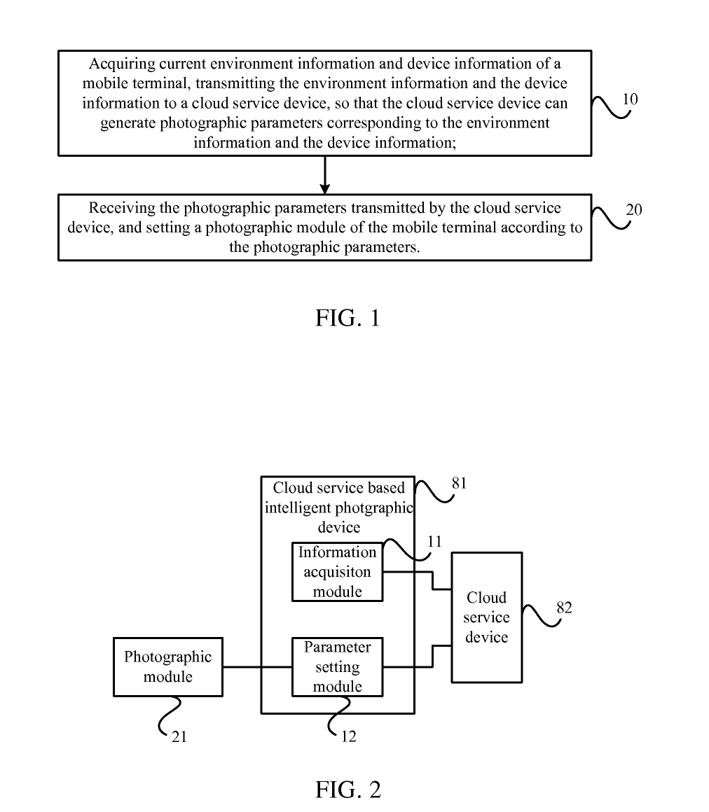

FIG. 2 is a structural schematic diagram of a cloud service based intelligent photographic device provided in Embodiment 3 of the present invention. As shown in FIG. 2, the cloud service based intelligent photographic device 81 provided in this embodiment can implement each step in the cloud service based intelligent photographic method provided in any embodiment of the present invention, and will not be described in detail here. The cloud service based intelligent photographic device 81 provided in this embodiment, particularly includes an information acquisition module 11 and a parameter setting module 12. The information acquisition module 11 is configured to acquire current environment information and device information of a mobile terminal, and transmit the environment information and the device information to a cloud service device 82, so that the cloud service device 82 generates photographic parameters corresponding to the environment information and the device information. The parameter setting module 12 is configured to receive the photographic parameters transmitted by the cloud service device 82, and set a photographic module 21 of the mobile terminal according to the photographic parameters.

In practical application process, if the mobile terminal is provided with a communication module, then the information acquisition module 11 can transmit the environment information and the device information to the cloud service device 82 via the communication module of the mobile terminal, and the parameter setting module 12 can receive the photographic parameters transmitted by the cloud service device 82 via the communication module.

In the cloud service based intelligent photographic device 81 provided in this embodiment, the information acquisition module 11 acquires current environment information and device information of a mobile terminal, and transmits the environment information and the device information to the cloud service device 82, so that the cloud service device 82 generates photographic parameters corresponding to the environment information and the device information. The parameter setting module 12 receives the photographic parameters transmitted by the cloud service device 82, and sets the photographic module 21 of the mobile terminal according to the photographic parameters. Since the intelligent photographic device 81 can receive photographic parameters generated according to current environment information and device information from the cloud service device 82, the photographic parameters can be aimed at the current environment features and adapted to hardware setting of the mobile terminal, a user can shoot high-quality photographic works even without any photographic experience, thus intelligent setting of the photographic parameters can be achieved and photographing effect of the mobile terminal can be greatly enhanced.

### Embodiment 4

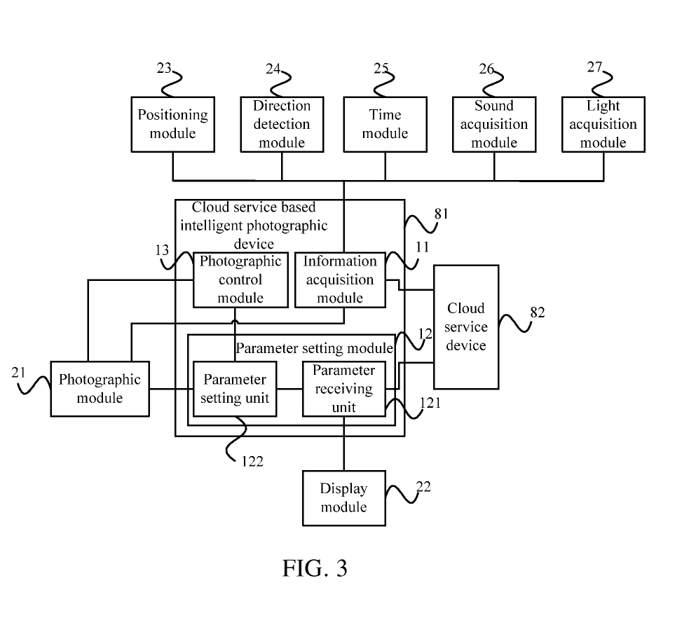

FIG. 3 is a structural schematic diagram of a cloud service based intelligent photographic device provided in Embodiment 4 of the present invention. As shown in FIG. 3, the cloud service based intelligent photographic device 81 provided in this embodiment is based on the embodiment in FIG. 2, the information acquisition module 11 is further configured to acquire the current position information from a positioning module 23 of the mobile terminal, acquire current orientation information from a direction detection module 24 of the mobile terminal, and acquire current time information from a time module 25 of the mobile terminal, and form the environment information based on the position information, the orientation information and the time information. By taking the position information, the orientation information and the time information as the environment information, the cloud service device 82 can determine the current environmental situation and weather condition according to the environment information, as the guidance for the photographic parameters to send, so that the photographic parameters can be aimed at the user's current environment.

In this embodiment, the information acquisition module 11 is further configured to acquire environmental noise information from a sound acquisition module 26 of the mobile terminal, acquire a frame of image of a video stream acquired by the photographic module 21 in real time as an image to be photographed, and generate subject information to be photographed according to the image to be photographed, and form the environment information based on the position information, the orientation information, the time information, the environmental noise information and the subject information to be photographed. By taking the environmental noise information and the subject information to be photographed as the environment information, the cloud service device 82 can make more comprehensive analysis on the environmental situation in which the user is located, so that the photographic parameters can be more targeted.

In this embodiment, the information acquisition module 11 is further configured to acquire light information from a light acquisition module 27 of the mobile terminal, and form the environment information based on the position information, the orientation information, the time information, and the light information.

In this embodiment, the parameter setting module 12 can particularly include a parameter receiving unit 121 and a parameter setting unit 122. The parameter receiving unit 121 is configured to receive multiple sets of the photographic parameters transmitted by the cloud service device 82, and display the multiple sets of photographic parameters via a display module 22 of the mobile terminal. The parameter setting unit 122 is configured to determine photographic parameters corresponding to parameter selection information according to the received parameter selection information input by a user, and set the photographic module 21 according to the photographic parameters corresponding to the parameter selection information. By sending multiple sets of photographic parameters to the user for selection, the user can get involved in selecting and setting the photographic parameters, and can select according to the user's own preferences, so that the selected photographic parameters are more desirable to the user.

Further, in this embodiment, the cloud service based intelligent photographic device 81 also can include a photographic control module 13. The photographic control module 13 is configured to control the photographic module 21 to perform a photographing operation. Particularly, after the parameter setting unit 122 finishes the parameter setting of the photographic module 21, it can trigger the photographic control module 13 to control the photographic module 21 to perform the photographing operation. An intelligent automatic photographing of the mobile terminal can be achieved by setting the photographic control module 13, the operational steps have been greatly simplified, and therefore a user with absolutely no photographic experience can obtain desirable photographic works.

### Embodiment 5

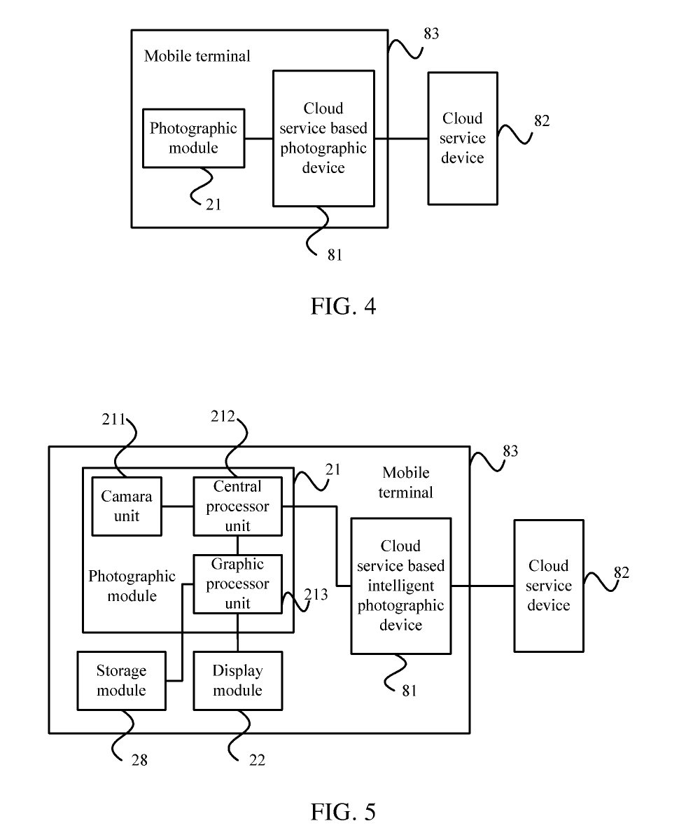

FIG. 4 is a structural schematic diagram of a terminal provided in Embodiment 5 of the present invention. As shown in FIG. 4, the mobile terminal 83 provided in this embodiment includes a photographic module 21, and further includes the cloud service based intelligent photographic device 81 provided in any embodiment of the present invention.

In the mobile terminal 83 provided by this embodiment, by setting the cloud service based intelligent photographic device 81, the intelligent photographic device 81 acquires current environment information and device information of the mobile terminal 83, transmits the environment information and the device information to a cloud service device 82, so that the cloud service device 82 generates photographic parameters corresponding to the environment information and device information, and receives the photographic parameters transmitted by the cloud service device 82, and sets a photographic module 21 of the mobile terminal 83 according to the photographic parameters. Since the intelligent photographic device 81 can receive photographic parameters generated according to current environment information and device information from the cloud service device 82, the photographic parameters can be aimed at the current environment features and adapted to hardware setting of the mobile terminal 83, a user can shoot high-quality photographic works even without any photographic experience, thus intelligent setting of the photographic parameters can be achieved and photographing effect of the mobile terminal 83 can be greatly enhanced.

The mobile terminal 83 also can include a positioning module, a direction detection module, a time module, a sound acquisition module and a light acquisition module, then the cloud service based intelligent photographic device 81 can respectively acquire position information, orientation information, time information, environmental noise information, and light information from the above modules, to form the environment information.

### Embodiment 6

FIG. 5 is a structural schematic diagram of a mobile terminal provided in Embodiment 6 of the present invention. As shown in FIG. 5, in this embodiment, the mobile terminal 83 also can include a display module 22, a photographic module 21 which includes a camera unit 211, a central processor unit 212 and a graphics processor unit 213. The camera unit 211 is configured to acquire a video stream in real time. The central processor unit 212 is configured to acquire each frame of image of a video stream acquired by the camera unit 211 in real time, generate at least one texture according to each frame of image, generate a parameter matrix according to the photographic parameters, and transmit the at least one texture and the parameter matrix to the graphics processor unit 213. The graphics processor unit 213 is configured to process the at least one texture according to the parameter matrix, generate the processed image and transmit it to the display module 22.

Particularly, the central processor unit 212 can be realized by a central processing unit (Central Processing Unit, CPU) or a micro control unit (Micro Control Unit, MCU) of the mobile terminal 83, and the graphics processor unit 213 can be realized by a graphics processing unit (Graphic Processing Unit, GPU) of the mobile terminal 83.

When the camera unit 211 starts to work, the camera unit 211 acquires a video stream in real time, particularly, the video stream consists of successive frames of image, and the central processor unit 212 acquires each frame of image of the video stream acquired in real time and generates at least one texture according to each frame of the image. Particularly, the graphics processor unit 213 can be based on an open graphics library (Open Graphics Library, OpenGL) technique, and the texture can be an OpenGL texture. The number of the generated textures particularly can be set in advance, or adjusted in real time according to the requirement of the processing scenario. The central processor unit 212 generates a corresponding parameter matrix according to the photographic parameters, and the parameter matrix can be parsed and executed by the graphics processor unit 213. The user can preview the effect of the processed image in real time via the display module 22. The central processor unit 212 converts and integrates the photographic parameters, and coordinates processing resources, the graphics processor unit 213 correspondingly processes the texture, and the processing of the video stream acquired in real time is implemented via the cooperation of central processor unit 212 and the graphics processor unit 213.

Further, in this embodiment, the mobile terminal 83 also includes a storage module 28. Correspondingly, the graphics processor unit 213 is further configured to perform face recognition or text recognition to the processed image upon received photographing instruction, focus on the recognized face regions or text regions, and store the focused image in the storage module 28 after encoding. By means of face recognition or text recognition, when the subject to be photographed is mainly a person or a symbolic text, the clarity of the subject to be photographed can be improved and the photographing effect can be further improved.

It should be noted that, the photographing in the above embodiment both includes picture photographing and video photographing, after the video stream acquired in real time is performed the above processing, the process of encoding and storing pictures or videos in the prior art can be used to encode and store the obtained pictures or videos, and will not be described in detail here.

Persons skilled in the art may appreciate that, all or partial steps of the above method embodiments can be implemented by a program instructing related hardware. The program can be stored in a computer readable medium. When the program is executed, the steps in the above method embodiments are performed; the storage medium includes various media capable of storing program codes, such as a read only memory (ROM), a random access memory (RAM), a floppy disk, or an optical disk and the like.

Finally, it should be noted that the above embodiments are merely provided for describing the technical solutions of the present invention, but not intended to limit the present invention. It should be understood by persons skilled in the art that although the present invention has been described in detail with reference to the foregoing embodiments, modifications can be made to the technical solutions described in the foregoing embodiments, or equivalent replacements can be made to partial or all technical features in the technical solutions; however, such modifications or replacements do not cause the essence of corresponding technical solutions to depart from the scope of the embodiments of the present invention.

What is claimed is:

1. A cloud service based intelligent photographic method, comprising:
acquiring current environment information and device information of a mobile terminal, transmitting the environment information and the device information to a cloud service device, so that the cloud service device generates photographic parameters corresponding to the environment information and the device information; and
receiving the photographic parameters transmitted by the cloud service device, and setting a photographic module of the mobile terminal according to the photographic parameters.

2. The cloud service based intelligent photographic method according to claim 1, wherein the acquiring the current environment information comprises:
acquiring current position information from a positioning module of the mobile terminal, acquiring current orientation information from a direction detection module of the mobile terminal, and acquiring current time information from a time module of the mobile terminal, and forming the environment information based on the position information, the orientation information and the time information.

3. The cloud service based intelligent photographic method according to claim 2, wherein, before the forming the environment information based on the position information, the orientation information and the time information, the method further comprises:
acquiring environmental noise information from a sound acquisition module of the mobile terminal, acquiring a frame of image of a video stream acquired by the photographic module in real time as an image to be photographed, and generating subject information to be photographed according to the image to be photographed;
correspondingly, the forming the environment information based on the position information, the orientation information and the time information comprises:
forming the environment information based on the position information, the orientation information, the time information, the environmental noise information and the subject information to be photographed.

4. The cloud service based intelligent photographic method according to claim 2, wherein, before the forming the environment information based on the position information, the orientation information and the time information, the method further comprises:
acquiring light information from a light acquisition module of the mobile terminal;
correspondingly, the forming the environment information based on the position information, the orientation information and the time information comprises:
forming the environment information based on the position information, the orientation information, the time information, and the light information.

5. The cloud service based intelligent photographic method according to claim 1, wherein the receiving the photographic parameters transmitted by the cloud service device, and setting a photographic module of the mobile terminal according to the photographic parameters, comprise:
receiving multiple sets of the photographic parameters transmitted by the cloud service device, and displaying the multiple sets of photographic parameters via a display module of the mobile terminal;
according to received parameter selection information input by a user, determining photographic parameters corresponding to the parameter selection information, and setting the photographic module according to the photographic parameters corresponding to the parameter selection information.

6. The cloud service based intelligent photographic method according to claim 1, wherein, after setting the photographic module of the mobile terminal according to the photographic parameters, the method further comprises:
controlling the photographic module to perform a photographing operation.

7. The cloud service based intelligent photographic method according to claims 1, wherein the photographic parameters comprise at least one of the following:
a nonlinear processing parameter, a color temperature processing parameter, a brightness processing parameter, a contrast processing parameter, a saturation processing parameter, a hue processing parameter, an exposure processing parameter, a focal distance parameter, an aperture parameter, a shutter parameter, an exposure compensation parameter, and a photosensibility parameter.

8. A cloud service based intelligent photographic device, comprising:
an information acquisition module, configured to acquire current environment information and device information of a mobile terminal, transmit the environment information and the device information to a cloud service device, so that the cloud service device generates photographic parameters corresponding to the environment information and the device information; and
a parameter setting module, configured to receive the photographic parameters transmitted by the cloud service device, and set a photographic module of the mobile terminal according to the photographic parameters.

9. The cloud service based intelligent photographic device according to claim 8, wherein the information acquisition module is further configured to acquire the current position information from a positioning module of the mobile terminal, acquire current orientation information from a direction detection module of the mobile terminal, and acquire current time information from a time module of the mobile terminal, and form the environment information based on the position information, the orientation information and the time information.

10. The cloud service based intelligent photographic device according to claim 9, wherein:
the information acquisition module is further configured to acquire environmental noise information from a sound acquisition module of the mobile terminal, acquire a frame of image of a video stream acquired by the photographic module in real time as an image to be photographed, and generate subject information to be photographed according to the image to be photographed, and form the environment information based on the position information, the orientation information, the time information, the environmental noise information and the subject information to be photographed form.

11. The cloud service based intelligent photographic device according to claim 9, wherein:
the information acquisition module is further configured to acquire light information from a light acquisition module of the mobile terminal, and form the environment information based on the position information, the orientation information, the time information, and the light information.

12. The cloud service based intelligent photographic device according to claim 8, wherein the parameter setting module comprises:
a parameter receiving unit, configured to receive multiple sets of the photographic parameters transmitted by the cloud service device, and display the multiple sets of photographic parameters via a display module of the mobile terminal;
a parameter setting unit, configured to, according to received parameter selection information input by a user, determine photographic parameters corresponding to the parameter selection information, and set the photographic module according to the photographic parameters corresponding to the parameter selection information.

13. The cloud service based intelligent photographic device according to claim 8, further comprising:
a photographic control module, configured to control the photographic module to perform a photographing operation.

14. A mobile terminal comprising a photographic module, further comprising:
the cloud service based intelligent photographic device according to claim 8.

15. The mobile terminal according to claim 14, further comprising a display module;
wherein, the photographic module includes a camera unit, a central processor unit and a graphics processor unit;
the camera unit is configured to acquire a video stream in real time;
the central processor unit is configured to acquire each frame of image of a video stream acquired by the camera unit in real time, generate at least one texture according to each frame of image, generate a parameter matrix according to the photographic parameters, and transmit the at least one texture and the parameter matrix to the graphics processor unit;
the graphics processor unit is configured to process the at least one texture according to the parameter matrix, generate a processed image and transmit it to the display module.

16. The mobile terminal according to claim 14, further comprising a storage module;
wherein, the graphics processor unit is correspondingly further configured to perform face recognition or text recognition to the processed image upon received photographing instruction, focus on the recognized face regions or text regions, and store the focused image in the storage module after encoding.
